(19) United States
(12) Patent Application Publication
(10) Pub. No.: US 2016/0308605 A1
(43) Pub. Date: Oct. 20, 2016

(54) APPARATUS AND METHOD FOR DRIVING OPTICAL SOURCE FOR OPTICAL FIBER LINK MONITORING APPARATUS

(71) Applicant: ELECTRONICS AND TELECOMMUNICATIONS RESEARCH INSTITUTE, Daejeon-si (KR)

(72) Inventors: Hun Sik KANG, Daejeon-si (KR); Jong Hyun LEE, Daejeon-si (KR); Jyung Chan LEE, Daejeon-si (KR); Seung IL MYONG, Daejeon-si (KR)

(21) Appl. No.: 15/099,157

(22) Filed: Apr. 14, 2016

(30) Foreign Application Priority Data
Apr. 15, 2015 (KR) 10-2015-0053297

(51) Int. Cl. H04B 10/077; H04B 1/00; H04B 10/50; H04B 10/67; H04B 10/25

(52) U.S. Cl. CPC H04B 10/0775; H04B 10/67; H04B 10/2504; H04B 10/503; H04B 1/0007

(57) ABSTRACT

An apparatus and method for driving an optical source for an optical fiber link monitoring apparatus. The apparatus for driving an optical source for an optical fiber link monitoring apparatus includes a laser part configured to output probe light that corresponds to a bipolar code probe signal; an optical receiver configured to convert reflected light, which has travelled back from an optical fiber link after transmission of the bipolar probe light, into an electrical signal; and a direct-current (DC) canceller configured to remove a DC offset component from the electrical signal generated by the optical receiver.

### CROSS-REFERENCE TO RELATED APPLICATION(S)

This application claims priority from Korean Patent Application No. 10-2015-0053297, filed on Apr. 15, 2015, in the Korean Intellectual Property Office, the disclosure of which is incorporated herein by reference in its entirety.

### BACKGROUND

1. Field

The following description relates to optical fiber link monitoring, and more particularly, to an apparatus and method for driving an optical source for an optical fiber link monitoring apparatus.

2. Description of Related Art

An optical time domain reflectometer is one of the most widely used methods to locate flaws in an optical fiber link. Generally, the OTDR sends out optical pulses of short duration to an optical fiber link, and measures light that has been reflected back from the optical fiber link during the propagation of the optical pulses, so as to locate the losses or flaws of said optical fiber link or another optical fiber link.

Mainly there are two types of reflections that can occur in optical fibers. The first type of reflection occurs due to Rayleigh reflection, whereby parts of the scattered light are reflected from an optical fiber. The second type of reflection is Fresnel reflection, which occurs at the interface of two materials of the optical fiber that have different refractive indices. The amount of Rayleigh reflection increases with the intensity of incident light, while the amount of Fresnel reflection increases proportionally to the difference between two refractive indices.

For an OTDR that uses a single optical pulse, the accuracy of the OTDR to locate flaws in an optical fiber link may conflict with the measurable length of the optical fiber link. In other words, if the OTDR uses a narrower optical pulse, the accuracy of locating the flaws in the optical fiber link may increase, whereas less Rayleigh reflection occurs, so that it is not possible for said OTDR to inspect a longer length of optical fiber link.

To overcome the above drawback, a code-based OTDR that uses a code pulse has been introduced, but it requires an additional signal processing process to convert a bipolar code into a unipolar form.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The following description relates to an apparatus and method for driving an optical source for a code-based optical fiber link monitoring apparatus, for which said apparatus and method generate and output bipolar probe light that corresponds to a bipolar code probe signal.

In one general aspect, there is provided an apparatus for driving an optical source for an optical fiber link monitoring apparatus, the apparatus including: a laser part configured to output probe light that corresponds to a bipolar code probe signal; an optical receiver configured to convert reflected light, which has travelled back from an optical fiber link after transmission of the bipolar probe light, into an electrical signal; and a direct-current (DC) canceller configured to remove a DC offset component from the electrical signal generated by the optical receiver.

The laser part may include a bipolar driving signal generator configured to generate bipolar driving signal A and bipolar driving signal B based on the bipolar code probe signal, a laser driver configured to supply current to a laser based on the generated bipolar driving signal A and B, and the laser configured to generate and output the bipolar probe light according to the supplied current.

The bipolar driving signal generator may generate the bipolar driving signals A and B in such a manner that they have the same value during the code interval, but have different values during the non-code interval.

The bipolar driving signal generator may generate the bipolar driving signal A by converting “−1” into “0” in a code interval of the bipolar code probe signal, while retaining “0” in a non-code interval, and generate the bipolar driving signal B by converting “−1” into “0” in a code interval of the bipolar code probe signal while converting a value of a non-code interval of the bipolar code probe signal into “+1.

The laser driver may supply a predetermined current to the laser during a non-code interval of the bipolar code probe signal, supplies twice as much as the predetermined current to the laser during “+1” code interval of the bipolar code probe signal, and cut off the supply of current to the laser during “−1” code interval of the bipolar code probe signal.

The laser driver may include switch A controlled by the bipolar driving signal A, switch B controlled by the bipolar driving signal B, and a current supply configured to supply current to the laser according to ON/OFF operations of the switches A and B.

The apparatus may further include a probe signal generator configured to generate the bipolar code probe signal for monitoring the optical fiber link.

The apparatus may further include an optical coupler configured to transmit the bipolar probe light output from the laser part to the optical fiber link, and to receive the reflected light that has travelled back from the optical fiber link.

The apparatus may further include an amplifier configured to adjust an amplitude of an electrical signal with the DC offset component removed; and an analog-to-digital (A/D) converter configured to convert the amplitude-adjusted electrical signal into a digital signal.

In another general aspect, there is provided a method for driving an optical source for an optical fiber link monitoring apparatus, the method including: outputting bipolar probe light that corresponds to a bipolar code probe signal; converting reflected light, which has travelled back from an optical fiber link after transmission of the bipolar probe light, into an electrical signal; and removing a DC offset component from the electrical signal.

The outputting of the bipolar probe signal may include generating bipolar driving signal A and bipolar driving signal B based on the bipolar code probe signal, supplying current to a laser based on the generated bipolar driving signals A and B, and generating and outputting the bipolar probe light according to the supplied current.

The generating of the bipolar driving signals A and B may include generating the bipolar driving signals A and B in such a manner that they have the same value during the code interval, but have different values during the non-code interval.

The generating of the bipolar driving signals A and B may include generating the bipolar driving signal A by converting “−1” into “0” in a code interval of the bipolar code probe signal, while retaining “0” in a non-code interval, and generating the bipolar driving signal B by converting “−1” into “0” in a code interval of the bipolar code probe signal while converting a value of a non-code interval of the bipolar code probe signal into “+1.”

The supplying of the current to the laser may include supplying a predetermined current to the laser during a non-code interval of the bipolar code probe signal, supplying twice as much as the predetermined current to the laser during “+1” code interval of the bipolar code probe signal, and cutting off the supply of current to the laser during “−1” code interval of the bipolar code probe signal.

The method may further include generating the bipolar code probe signal for monitoring the optical fiber link.

The method may further include transmitting the bipolar probe light to the optical fiber link; and receiving the reflected light that has travelled back from the optical fiber link.

The method may further include adjusting an amplitude of an electrical signal with the DC offset component removed; and converting the amplitude-adjusted electrical signal into a digital signal.

Other features and aspects will be apparent from the following detailed description, the drawings, and the claims.

### BRIEF DESCRIPTION OF THE DRAWINGS

FIG. 1 is a diagram illustrating an example of an apparatus for driving an optical source for an optical fiber link monitoring apparatus according to an exemplary embodiment.

FIG. 2 is a diagram illustrating in detail a laser driver of FIG. 1.

FIG. 3 is a circuit diagram illustrating an example of the laser driver of FIG. 1.

FIG. 4 is a diagram for explaining operations of the optical source driving apparatus of FIG. 1.

FIG. 5 is a diagram illustrating another example of the apparatus for driving an optical source for an optical fiber link monitoring apparatus.

FIG. 6 is a flowchart illustrating an example of a method for driving an optical source for an optical fiber link monitoring apparatus according to an exemplary embodiment.

FIG. 7 is a flowchart illustrating in detail generation and output of bipolar probe light of FIG. 6.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

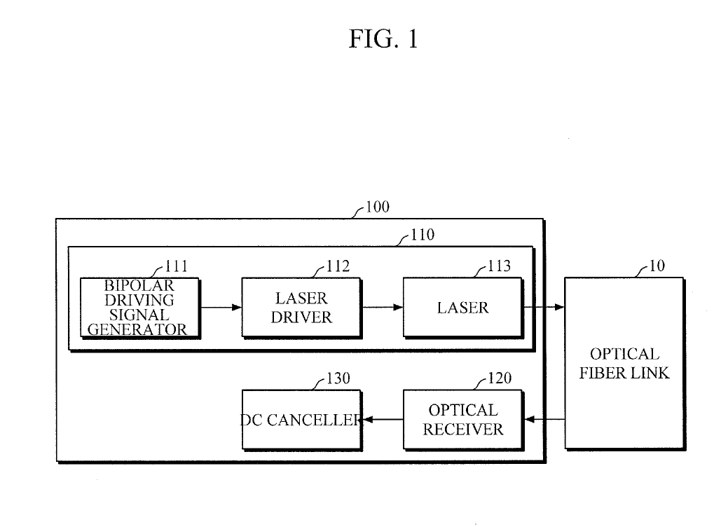

FIG. 1 is a diagram illustrating an example of an apparatus for driving an optical source for an optical fiber link monitoring apparatus according to an exemplary embodiment.

Referring to FIG. 1, an apparatus 100 for driving an optical source may include a laser part 110, an optical receiver 120, and a direct-current (DC) canceller 130.

The laser part 110 may generated and output bipolar probe light that corresponds to a probe signal (hereinafter, will be referred to as “a bipolar code probe signal”) made up of a bipolar code having values of +1 and −1.

Unlike a single pulse signal, a bipolar code-based signal is not suitable to be transmitted through a photoelectric element, such as a laser diode/direct optical receiver, which is widely used in optical communications. Because a laser diode/direct optical receiver transmits/receives the intensity of an optical signal, i.e., the electric power of said signal, it, by nature, sends out a unipolar signal. For this reason, in the case of monitoring the optical fiber link using the bipolar code-based signal, additional signal processing is generally required to convert a bipolar code-based signal into a unipolar signal.

According to the exemplary embodiment, the laser part 110 may generate and output bipolar probe light that corresponds to the bipolar code-based signal (i.e., the bipolar code probe signal) without converting said bipolar code probe signal into a unipolar signal. To this end, the laser part 110 may include a bipolar driving signal generator 111, a laser driver 112, and a laser 113.

The bipolar driving signal generator 111 may generate bipolar driving signal A and bipolar driving signal B based on the bipolar code probe signal so as to output the bipolar probe light that corresponds to the bipolar code probe signal through the laser 113.

According to an exemplary embodiment, the bipolar driving signal generator 111 may generate bipolar driving signal A and bipolar driving signal B, in such a manner that they have the same value during the code interval, but have different values during the non-code interval. For example, the bipolar driving signal generator 111 may generate bipolar driving signal A by retaining “+1” or converting “−1” into “0” in a code interval of the bipolar code probe signal, while retaining “0” in a non-code interval. Also, the bipolar driving signal generator 111 may generate bipolar driving signal B by retaining “+1” or converting “−1” into “0” in a code interval of the bipolar code probe signal while converting “0” into “+1” in a non-code interval.

For example, it is assumed that the optical fiber link 10 is monitored using a bipolar code probe signal that is made up of bipolar code (+1, −1) and has “0” during a non-code interval. In this case, the bipolar driving signal generator 111 may generate bipolar driving signal A and bipolar driving signal B, for which bipolar driving signal A has (+1,0) for a code interval and “0” for a non-code interval, and bipolar driving signal B has (+1,0) for a code interval and “+1” for a non-code interval.

The above may be represented by equations below.

$$\begin{matrix}{B}_{k}^{+} = \{ \begin{matrix}\frac{1}{2} ( 1 + {B}_{k} ) , Code Interval \\ 0 , Non \text{-} code Interval\end{matrix} \} & ( 1 ) \\ {B}_{k}^{-} = \{ \begin{matrix}\frac{1}{2} ( 1 + {B}_{k} ) , Code Interval \\ 1 , Non \text{-} code Interval\end{matrix} \} & ( 2 )\end{matrix}$$

Here, Bₖ⁺ denotes bipolar driving signal A, Bₖ⁻ denotes bipolar driving signal B, and Bₖ denotes a bipolar code probe signal.

The laser driver 112 may provide the laser 113 with current that corresponds to a laser power based on bipolar driving signals A and B, which are generated by the bipolar driving signal generator 111.

According to an exemplary embodiment, based on bipolar driving signals A and B, the laser driver 112 may supply predesignated current to the laser 113 during the non-code interval of the bipolar code probe signal, supply the laser with twice as much as the predesignated current during “+1” code interval, and cut off the supply of current to the laser 113 during “−1” code interval.

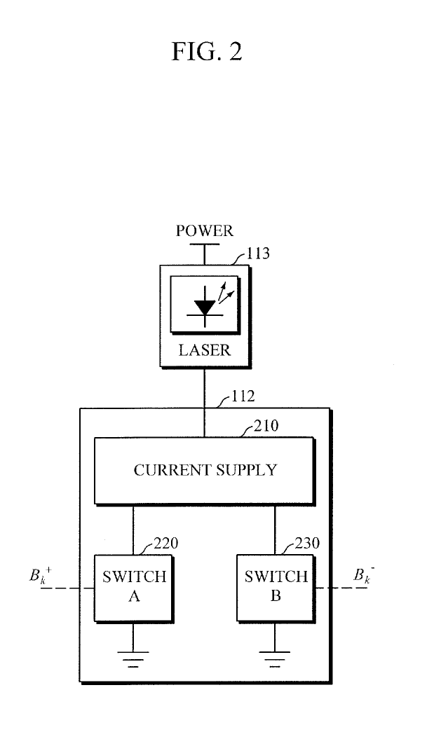

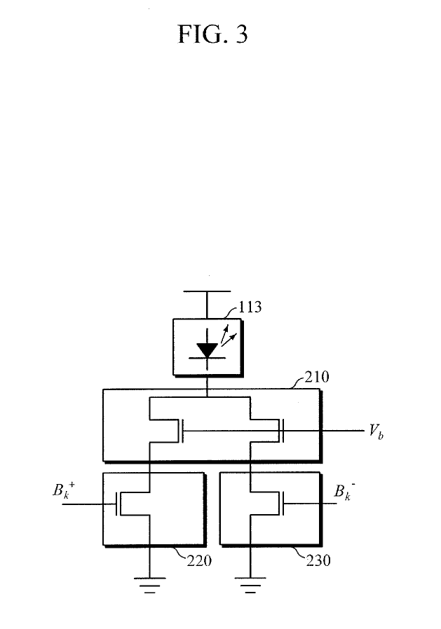

The laser driver 112 will be described later in detail with reference to FIGS. 2 and 3.

The laser 113 may convert an electrical signal into an optical signal according to the current supplied from the laser driver 112. The laser 113 may generate and output bipolar probe light that corresponds to the bipolar code probe signal, according to the current supplied from the laser driver 112.

The optical receiver 120 may receive reflected light travelling back from the optical fiber link and convert the reflected light into an electrical signal. At this time, the reflected light may include Rayleigh reflected light and Fresnel reflected light that both occur during the bipolar probe light being travelling along the optical fiber link.

The DC canceller 130 may remove a DC offset component from the electrical signal that is sent from the optical receiver 120.

The reflected light incoming to the optical receiver 120 initially exhibits an exponential curve for a certain period of time due to the Rayleigh reflection, and then changes to a pulse-like form due to the Fresnel reflection. The reflected light has a DC offset component, and when a signal converted from the reflected light undergoes amplification and A/D conversion, said signal loses the bipolar values that the initial probe signal carried during the transmission. Hence, in order to create the reflected light into a bipolar signal, the DC canceller 130 may remove a DC offset component from the electrical signal converted by the optical receiver.

Hereinafter, the laser driver 112 according to the exemplary embodiment will be described in detail with reference to FIGS. 2 and 3.

FIG. 2 is a diagram illustrating in detail the laser driver of FIG. 1.

Referring to FIG. 2, the laser driver 112 may include a current supply 210, switch A 220, and switch B 230.

The current supply 210 may supply the laser 113 with current that corresponds to a laser power according to ON/OFF operations of switch A 220 and switch B 230.

Switch A 220 may be switched on and/or off in response to bipolar driving signal A Bₖ⁺ so as to control the amount of current to be supplied to the laser 113.

Switch B 230 may be switched on and/or off in response to bipolar driving signal B Bₖ⁻ so as to control the amount of current to be supplied to the laser 113.

During the non-code interval of the bipolar code probe signal, bipolar driving signal A Bₖ⁻ has a value of 0, and bipolar driving signal B Bₖ⁻ has a value of +1. Thus, during the non-code interval, switch A 220 that is controlled in response to bipolar driving signal A Bₖ⁺ is switched off, while switch B 230 that is controlled in response to bipolar driving signal B Bₖ⁻ is switched on. Accordingly, the current supply 210 supplies the laser 113 with a predetermined current, and the laser 113, in turn, generates and outputs probe light of power that corresponds to the supplied current.

During “+1” code interval of the bipolar code probe signal, each of bipolar driving signal A Bₖ⁺ and bipolar driving signal B Bₖ⁻ has a value of +1, and hence switch A 220, which is controlled by bipolar driving signal A Bₖ⁺, and switch B 230, which is controlled by bipolar driving signal B Bₖ⁻ are both switched on. Accordingly, the current supply 210 supplies the laser 113 with twice as much as the predetermined current, and the power from the laser 113 becomes greater than the power during the non-code interval. As a result, the laser 113 generates and outputs probe light that corresponds to a bipolar signal with “+1”.

During “−1” code interval of the bipolar code probe signal, bipolar driving signal A Bₖ⁺ and bipolar driving signal B Bₖ⁻ both have a value of 0, and hence switch A 220, which is controlled by bipolar driving signal A Bₖ⁺, and switch B 230, which is controlled by bipolar driving signal B Bₖ⁻, are all switched off. Accordingly, the current supply 210 does not supply any current to the laser 113, and the laser 113 generates and outputs probe light that corresponds to a bipolar signal with “−1”.

FIG. 3 is a circuit diagram illustrating an example of the laser driver of FIG. 1.

Referring to FIGS. 2 and 3, the current supply 210 may consist of two NMOS transistors, whose operating current may be determined by a gate terminal V_{b}.

Switch A 220 may consist of one NMOS transistor, whose gate terminal may be controlled by bipolar driving signal A Bₖ⁺.

Switch B 230 may consist of one NMOS transistor, whose gate terminal may be controlled by bipolar driving signal Bₖ⁻.

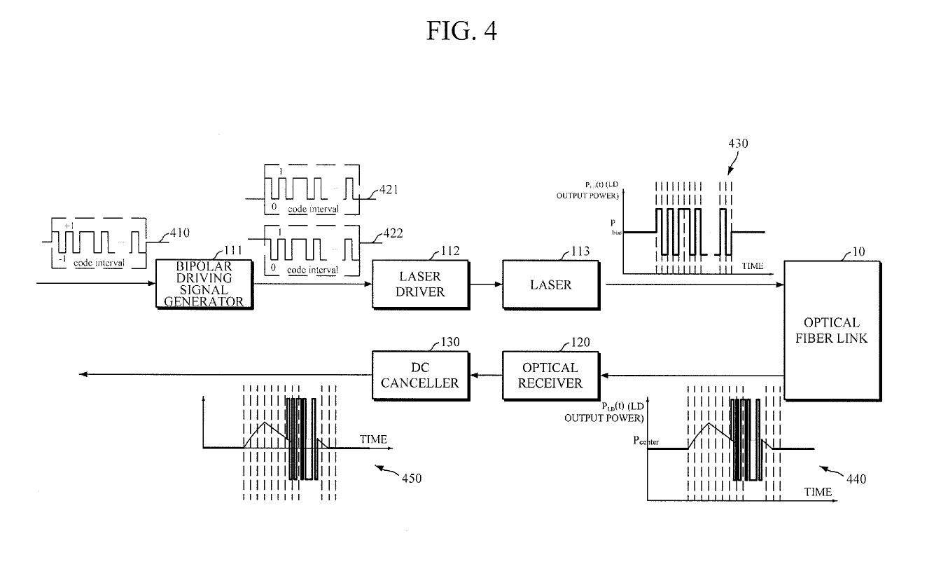

FIG. 4 is a diagram for explaining operations of the optical source driving apparatus of FIG. 1.

Referring to FIG. 4, the bipolar driving signal generator 111 receives a bipolar code probe signal 410 to generate bipolar driving signal A 421 using Equation 1, as well as bipolar driving signal B 422 using Equation 2, wherein the bipolar code probe signal 410 has either “+1” or “−1” during a code interval, and has “0” during a non-code interval.

As illustrated, during the code interval, bipolar driving signal A 421 and bipolar driving signal B 422 both have the same value, whereas during the non-code interval, bipolar driving signal A 421 has “0” and bipolar driving signal B 422 has “+1.”

Bipolar driving signal A 421 and bipolar driving signal B 422 from the bipolar driving signal generator 111 are input to the laser driver 112, and the laser driver 112, in turn, supplies the laser 113 with current that corresponds to the laser power, according to bipolar driving signal A 421 and bipolar driving signal B 422.

The laser 113 receives a predetermined current from the laser driver 112, then generates and outputs probe light with an output power of P_{bias} during the non-code interval of bipolar driving signal A 421 and bipolar driving signal B 422 (or during the non-code interval of the bipolar code probe signal 410).

In addition, the laser 113 is supplied with twice as much as the predetermined current from the laser driver 112, then generates and outputs an output power that corresponds to the bipolar signal with “+1” during “+1” code interval of bipolar driving signal A 421 and bipolar driving signal B 422 (or “+1” code interval of the bipolar code probe signal 410).

Also, the laser 113 does not receive any current from the laser driver 112 during “0” code interval of bipolar driving signal A 421 and bipolar driving signal B 422 (or during “−1” code interval of the bipolar code probe signal 410), and hence, the laser 133 generates and outputs probe light that corresponds to the bipolar signal with “−1.”

Reference numeral 430 denotes probe light output from the laser 113, and as illustrated, the probe light output from the laser 113 is of a bipolar format, as illustrated in drawings.

The probe light output from the laser 113 is transmitted to the optical fiber link 10, and the optical receiver 120 receives reflected light traveling back from the optical fiber link 10, which is caused by the Rayleigh reflection or Fresnel reflection of the probe light, and converts the received reflected light into an electrical signal.

Reference numeral 440 denotes the reflected light traveling back from the optical fiber link 10, and as shown in the drawing, the reflected light 440 shows a waveform that starts at an amplitude of P_{center}. That is, the reflected light 440 has an offset component.

In this case, as described above, the reflected light 440 initially exhibits an exponential curve for a certain period of time due to the Rayleigh reflection, and then changes to a pulse-like form due to the Fresnel reflection.

The DC canceller 130 removes a DC offset component from the electrical signal output from the optical receiver 120. As described above, if the reflected light 440 having the offset component is converted into the electrical signal, and then the electrical signal undergoes amplification and A/D conversion, said electrical signal loses the bipolar values that the initial probe signal carried during the transmission. Thus, in order to convert said reflected light 440 into a bipolar signal, the DC canceller 130 removes the DC offset component from the electrical signal converted by the optical receiver 120.

Reference numeral 450 denotes an electrical signal which results from removing the DC offset component from the electrical signal converted from the reflected light, and as illustrated, said electrical signal 450 has bipolar values.

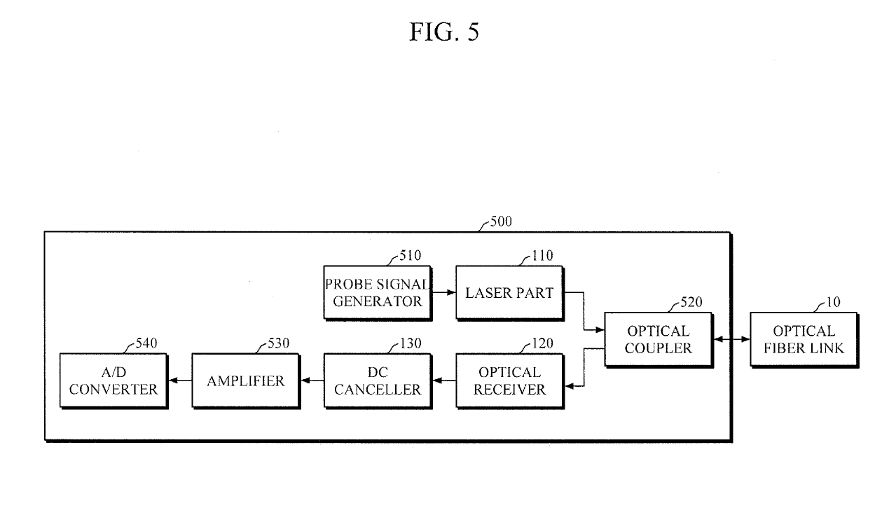

FIG. 5 is a diagram illustrating another example of the apparatus for driving an optical source for an optical fiber link monitoring apparatus.

Referring to FIGS. 1 and 5, an apparatus 500 for driving an optical source may include a probe signal generator 510, an optical coupler 520, an amplifier 530, and an A/D converter 540 in addition to the elements of the apparatus 100 of FIG. 1.

The probe signal generator 510 may generate a bipolar code probe signal for monitoring an optical fiber link 10. The bipolar code probe signal may include a bipolar signal with “+1” and “−1”.

The optical coupler 520 may transmit the probe light generated by the laser part 110 to the optical fiber line 10, and receive reflected light traveling back from the optical fiber link 10.

The amplifier 530 may adjust the amplitude of an electrical signal with a DC offset component removed, such that the amplitude can falls within an input range of the A/D converter 540.

The A/D converter 540 may convert an analog signal into a digital signal.

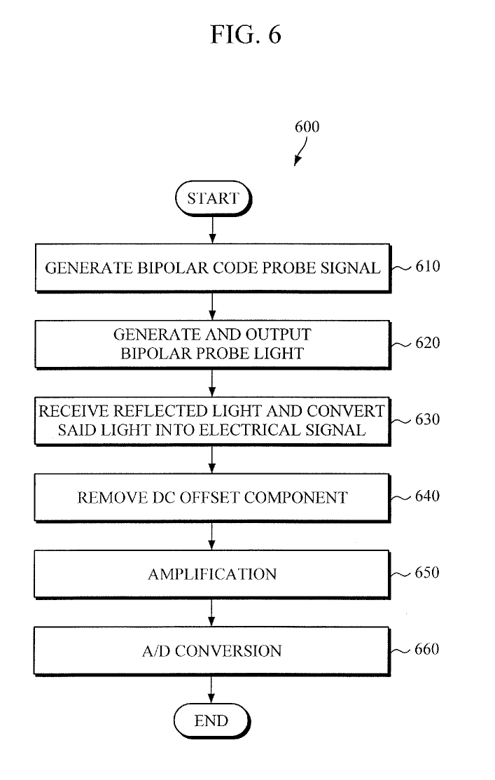

FIG. 6 is a flowchart illustrating an example of a method for driving an optical source for an optical fiber link monitoring apparatus according to an exemplary embodiment.

Referring to FIG. 6, an optical source driving method 600 begins with generating of a bipolar code probe signal for monitoring an optical fiber link, as depicted in 610. For example, an apparatus for driving an optical source may generate a probe signal made up of a bipolar code having values of +1 and −1.

Then, the apparatus generates and outputs bipolar probe light that corresponds to the generated bipolar code probe signal, as depicted in 620.

Unlike a single pulse signal, a bipolar code-based signal is not suitable to be transmitted through a photoelectric element, such as a laser diode/direct optical receiver, which is widely used in optical communications. Because a laser diode/direct optical receiver transmits/receives the intensity of an optical signal, i.e., the electric power of said signal, it, by nature, sends out a unipolar signal. For this reason, in the case of monitoring the optical fiber link using the bipolar code-based signal, additional signal processing is generally required to convert the bipolar code-based signal into a unipolar signal.

According to an exemplary embodiment, the apparatus for driving an optical source may generate and output bipolar probe light that corresponds to a bipolar code-based signal, i.e., the bipolar code probe signal, without converting said bipolar code probe signal into a unipolar signal.

Then, in 630, after the transmission of the probe light, the optical source driving apparatus receives light reflection that has travelled back from the optical fiber link, and the apparatus converts the reflected light into an electrical signal.

In 640, a DC offset component is removed from the electrical signal.

The reflected light received by the optical source driving apparatus initially exhibits an exponential curve for a certain period of time due to the Rayleigh reflection, and then changes to a pulse-like form due to the Fresnel reflection. The reflected light has a DC offset component, and when a signal converted from the reflected light undergoes amplification and A/D conversion, said signal loses the bipolar values that the initial probe signal carried during the transmission. Hence, in order to create the reflected light into a bipolar signal, the optical source driving apparatus may remove a DC offset component from the electrical signal converted from the reflected light.

Then, the amplitude of the electrical signal with the DC offset component removed is amplified, as depicted in 650.

The amplified electrical signal is converted into a digital signal, as depicted in 660.

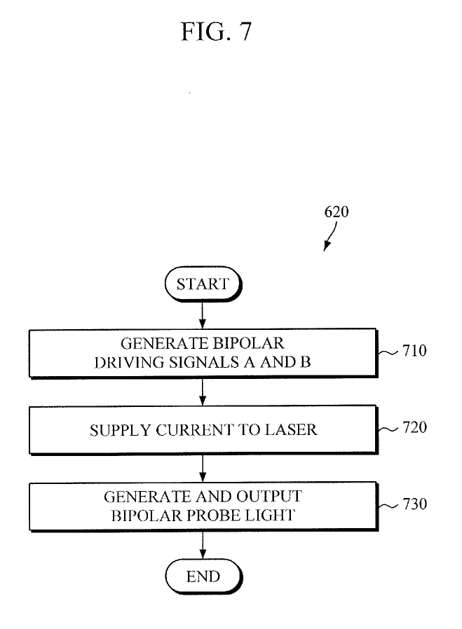

FIG. 7 is a flowchart illustrating in detail the generation and output of the bipolar probe light of FIG. 6.

Referring to FIG. 7, in the generation and output of the bipolar probe light, which is depicted in 620 of FIG. 6, bipolar driving signal A and bipolar driving signal B are generated based on the bipolar code probe signal in order to output the bipolar probe light that corresponds the bipolar code probe signal, as depicted in 710.

According to an exemplary embodiment, the optical source driving apparatus may generate bipolar driving signal A and bipolar driving signal B in such a manner that they have the same value during the code interval, but have different values during the non-code interval. For example, said apparatus may generate bipolar driving signal A using Equation 1 above, and generate bipolar driving signal B using Equation 2 above.

Then, in 720, according to bipolar driving signal A and bipolar driving signal B, a laser is supplied with current that corresponds to a laser power. For example, during the non-code interval of the bipolar code probe signal, a predetermined current is provided to the laser based on said bipolar driving signals A and B, during “+1” code interval of the bipolar code probe signal, twice as much as the predetermined current is provided to the laser, and during “−1” code interval, the supply of current to the laser is cut off.

In 730, the bipolar probe light is generated by converting the electrical signal according to the current supplied to the laser, and then is output.

According to the exemplary embodiments as described above, it is possible to transmit a bipolar code intact at a time in a code-based optical fiber link monitoring apparatus, thereby reducing the measurement time for optical fiber link.

Also, it is possible to receive a bipolar signal, thereby reducing complexity of code-based optical time-domain reflectometer (OTDR).

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for driving an optical source for an optical fiber link monitoring apparatus, the apparatus comprising:
a laser part configured to output probe light that corresponds to a bipolar code probe signal;
an optical receiver configured to convert reflected light, which has travelled back from an optical fiber link after transmission of the bipolar probe light, into an electrical signal; and
a direct-current (DC) canceller configured to remove a DC offset component from the electrical signal generated by the optical receiver.

2. The apparatus of claim 1, wherein the laser part comprises
a bipolar driving signal generator configured to generate bipolar driving signal A and bipolar driving signal B based on the bipolar code probe signal,
a laser driver configured to supply current to a laser based on the generated bipolar driving signal A and B, and
the laser configured to generate and output the bipolar probe light according to the supplied current.

3. The apparatus of claim 2, wherein the bipolar driving signal generator generates the bipolar driving signals A and B in such a manner that they have the same value during the code interval, but have different values during the non-code interval.

4. The apparatus of claim 2, wherein the bipolar driving signal generator generates the bipolar driving signal A by converting “−1” into “0” in a code interval of the bipolar code probe signal, while retaining “0” in a non-code interval, and generates the bipolar driving signal B by converting “−1” into “0” in a code interval of the bipolar code probe signal while converting a value of a non-code interval of the bipolar code probe signal into “+1.

5. The apparatus of claim 2, wherein the laser driver supplies a predetermined current to the laser during a non-code interval of the bipolar code probe signal, supplies twice as much as the predetermined current to the laser during “+1” code interval of the bipolar code probe signal, and cuts off the supply of current to the laser during “−1” code interval of the bipolar code probe signal.

6. The apparatus of claim 2, wherein the laser driver comprises
switch A controlled by the bipolar driving signal A,
switch B controlled by the bipolar driving signal B, and
a current supply configured to supply current to the laser according to ON/OFF operations of the switches A and B.

7. The apparatus of claim 1, further comprising: a probe signal generator configured to generate the bipolar code probe signal for monitoring the optical fiber link.

8. The apparatus of claim 1, further comprising: an optical coupler configured to transmit the bipolar probe light output from the laser part to the optical fiber link, and to receive the reflected light that has travelled back from the optical fiber link.

9. The apparatus of claim 1, further comprising:
an amplifier configured to adjust an amplitude of an electrical signal with the DC offset component removed; and
an analog-to-digital (A/D) converter configured to convert the amplitude-adjusted electrical signal into a digital signal.

10. A method for driving an optical source for an optical fiber link monitoring apparatus, the method comprising:
outputting bipolar probe light that corresponds to a bipolar code probe signal;
converting reflected light, which has travelled back from an optical fiber link after transmission of the bipolar probe light, into an electrical signal; and
removing a DC offset component from the electrical signal.

11. The method of claim 10, wherein the outputting of the bipolar probe signal comprises generating bipolar driving signal A and bipolar driving signal B based on the bipolar code probe signal, supplying current to a laser based on the generated bipolar driving signals A and B, and generating and outputting the bipolar probe light according to the supplied current.

12. The method of claim 11, wherein the generating of the bipolar driving signals A and B comprises generating the bipolar driving signals A and B in such a manner that they have the same value during the code interval, but have different values during the non-code interval.

13. The method of claim 11, wherein the generating of the bipolar driving signals A and B comprises generating the bipolar driving signal A by converting “−1” into “0” in a code interval of the bipolar code probe signal, while retaining “0” in a non-code interval, and generating the bipolar driving signal B by converting “−1” into “0” in a code interval of the bipolar code probe signal while converting a value of a non-code interval of the bipolar code probe signal into “+1.”

14. The method of claim 11, wherein the supplying of the current to the laser comprises supplying a predetermined current to the laser during a non-code interval of the bipolar code probe signal, supplying twice as much as the predetermined current to the laser during “+1” code interval of the bipolar code probe signal, and cutting off the supply of current to the laser during “−1” code interval of the bipolar code probe signal.

15. The method of claim 10, further comprising:
generating the bipolar code probe signal for monitoring the optical fiber link.

16. The method of claim 10, further comprising:
transmitting the bipolar probe light to the optical fiber link; and
receiving the reflected light that has travelled back from the optical fiber link.

17. The method of claim 10, further comprising:
adjusting an amplitude of an electrical signal with the DC offset component removed; and
converting the amplitude-adjusted electrical signal into a digital signal.
